(19) United States
(12) Patent Application Publication
(10) Pub. No.: US 2007/0204508 A1
(43) Pub. Date: Sep. 6, 2007

(54) MATERIAL FOR REDUCING FADING OF MULCH DUE TO EXPOSURE TO ULTRAVIOLET LIGHT

(76) Inventors: Joseph W. Ferraro, Elizabeth, PA (US); Steven A. Buono, Afton, TN (US); Wallace H. Pippin, West Chester, PA (US)

Correspondence Address: LUEDEKA, NEELY & GRAHAM, P.C., P O BOX 1871, KNOXVILLE, TN, 37901, US

(21) Appl. No.: 11/623,789

(22) Filed: Jan. 17, 2007

Related U.S. Application Data
(60) Provisional application No. 60/779,506, filed on Mar. 6, 2006.

(51) Int. Cl. C09K 17/52

(52) U.S. Cl. 47/33

(57) ABSTRACT

The invention provides a mulch protective composition, methods for reducing fading of mulch, and non-fading mulch. The mulch protective composition is provided by a mixture of water and at least one component selected from an antioxidant, an ultraviolet absorber, an aqueous polymer dispersion, and mixtures of two or more of the foregoing. The composition is effective to reduce fading of mulch over time.

This application claims priority to U.S. provisional patent application No. 60/779,506 filed Mar. 6, 2006.

### FIELD OF THE DISCLOSURE

The disclosure relates to prevention of fading of colors of mulch materials and to mulch protective compositions. More particularly, the disclosure relates to a material for reducing fading of colors in mulch materials due to exposure to air oxidation and ultraviolet radiation.

### BACKGROUND AND SUMMARY

Most mulch materials used in landscaping applications consist of wood chips and wood fibers. When initially applied in a flower bed or other landscaping application, wood mulches are naturally dark brown or black in color, which is aesthetically desirable in many situations. In some applications, dyed mulch materials are used, such as red or blue mulches, to provide a desired decorative effect. Over time, however, the color of wood mulch tends to fade, thereby losing its desirable decorative effect.

Discoloration of wood chips and fibers used as mulch may be caused, in large part, by oxidation of the lignin and tannins in the wood pulp. In effect, the wood pulp is literally burning at a very slow rate. Oxidation of the mulch may also catalyzed by ultraviolet (UV) radiation from the sun which accelerates the discoloration of the mulch. Accordingly, there is a need for improved mulch and/or for methods and compositions that reduce or eliminate the fading tendencies of mulch over time.

In view of the foregoing and other needs, exemplary embodiments of the disclosure provide mulch protective compositions, methods for reducing fading of mulch, and non-fading mulch. The mulch protective composition is provided by a mixture of water and at least one component selected from an antioxidant, an ultraviolet absorber, an aqueous polymer dispersion, and mixtures of two or more of the foregoing. The composition is effective to reduce fading of mulch over time.

In one exemplary embodiment of the disclosure there is provided a method for reducing mulch fading. According to the method, a protective composition is applied to the mulch. The protective composition contains a mixture of water and at least one component selected from an antioxidant, an ultraviolet absorber, an aqueous polymer dispersion, and mixtures of two or more of the foregoing. The composition is effective to reduce fading of mulch over time.

In another exemplary embodiment of the disclosure there is provided a non-fading mulch that includes wood chips and a protective composition applied to the wood chips. The protective composition contains a mixture of water and at least one component selected from an antioxidant, an ultraviolet absorber, an aqueous polymer dispersion, and mixtures of two or more of the foregoing. The composition is effective to reduce fading of mulch over time.

While not desiring to be bound by theory, it is believed that coating the surface of the wood chips or wood fibers of the mulch with a particular composition may eliminate or reduce oxidation of the mulch, thereby preventing discoloration. The composition used to coat the mulch may be used without a colorant thereby preserving the natural color of the wood chips and fibers. However, other embodiments of the disclosure may provide colorant to enhance the aesthetic effect of the mulch in a landscaping setting.

### DETAILED DESCRIPTION OF EXEMPLARY EMBODIMENTS

According to an exemplary embodiment of the disclosure, landscaping mulch is coated with an aqueous mixture of water and at least one component selected from an antioxidant, an ultraviolet (UV) absorber, an aqueous polymer dispersion, and mixtures of two or more of the foregoing. The aqueous mixture may be applied to the mulch before or after disposing the mulch in a landscaping setting such as a flower bed, or landscape area adjacent a building. Application of the mixture to mulch may be effected by spraying the mulch with a pressure sprayer, washing the mulch in a vat, or otherwise contacting surfaces of the mulch chips and fibers with the mixture for a period of time sufficient to result in a thin even coating or to impregnate the mulch with an amount of mixture ranging from about forty (40) grams to about four hundred (400) grams per pound of mulch.

Suitable antioxidants that may be used to make the mixture include, but are not limited to, polymeric hindered phenols that are water soluble or water dispersible. Examples of suitable polymeric hindered phenols include alkylated reaction products of para-cresol and dicyclopentadiene, 1,3,5-trimethyl-2,4,6-tris(3,5-di butyl-4-hydroxy benzyl)benzene, 6-butyl-m-cresol, 4,4′-butylidene-bis(6-butyl-m-cresol) and p-nonylphenol, mixtures of polymeric hindered phenols and di-tridecylthiodipropionate, di-tert-butyl hindered phenol acid esters, mixtures of two or more of the foregoing, and the like.

Suitable UV absorbers include hindered amine and benzophenone type UV light absorbers. Non-limiting examples include, but are not limited to, N,N-di(2-hydroxyethyl) octadecylamine, N,N,N′-tri-(2-hydroxyethyl)-N′-octadecyl-1,3-propylene diamine, bis91,2,2,6,6-pentamethyl-4-piperidinyl)sebacate, methyl(1,2,2,6,6-pentamethyl-4-piperidinyl)sebacate, 2-(3′-tert-butyl-2′-hydroxy-5′-methylphenyl)-5-chlorobenzotriazole, 2,4-dihydroxybenzophenone, 2,2,4-trihydroxy-benzophenone, 2-hydroxy-4-n-octoxybenzophenone, mixtures of two or more of the foregoing, and the like.

The aqueous polymeric dispersions may be selected from carboxylated styrene-butadiene (SBR) latex dispersions, ethylene vinyl acetate copolymers, high molecular weight vinyl acrylic copolymers, alkylacrylate acrylonitrile-styrene copolymers, acrylic ester and styrene copolymer dispersions, and acrylic copolymer dispersions.

Optional ingredients that may be included in the aqueous mixture applied to the mulch may include dispersants and/or colorants. The dispersants may be selected from acrylic acid homopolymers, sodium salts of maleic anhydride and diisobutylene, and the like. Colorants may be selected from various pigments, such as carbon black, and aqueous pigment dispersions. Insecticides, fungicides and/or herbicides may also be included to deter insect infestation, fungus growth and weed growth. In some embodiments, antimicrobial agents may also be added to prolong decomposition time of the treated mulch.

Table I provides a non-limiting example of the aqueous polymer dispersion materials, antioxidant materials and ultraviolet absorber materials used in various embodiments of the protective material applied to the mulch. Table II provides percentages by weight of each material used in the embodiments of Table I.

TABLE I

| Component | Composition | Product Trade Name | Manufacturer |
|---|---|---|---|
| aqueous polymer | carboxylated styrene- | GENFLO 3003 | Omnova Solutions, Inc. |
| dispersion (APD) - latex | butadiene (SBR) latex | GENFLO 3810 | of Fairlawn, OH |
| | | ROVENE 4457 | Mallard-Creek Polymers, |
| | | ROVENE 4170 | Inc. of Charlotte, NC |
| | | ROVENE 6140 | |
| | | ROVENE 4019 | |
| | ethylene vinyl acetate | AIRFLEX 811 | Air Products of |
| | copolymer | AIRFLEX RB11 | Allentown, PA |
| | | AIRFLEX A405 | |
| | vinyl acrylic (VAC) | FLEXBOND 325 | |
| | acrylonitrile-styrene | ACRONAL S504 | BASF of Florham Park, |
| | (ABS) copolymer | ACRONAL S400 | NJ |
| | | ACRONAL NS567 | |
| | acrylic copolymer | ACRONAL OPTIVE | |
| | dispersion | ACRONAL OPTIVE 410 | |
| | | ACRONAL OPTIVE 130 | |
| antioxidant (AO) | hindered phenols | OCTOLITE WL | Tiarco Chemical of |
| | | OCTOLITE 424-50 | Dalton, GA |
| | | OCTOLITE 625 | Mazo of Norcross, GA |
| | | BNX 1076 | |
| | | BNX 1077 | |
| ultraviolet absorber | benzophenone | BLS 531 | |
| | hindered amine | BLS 292 | |
| | benzotriazole | BLS 1326 | |
| | benzotriazole/hindered | TINUVIN5151 | Ciba Specialty |
| | amine | | Chemicals, Inc. of Basel, |
| | | | Switzerland |
| dispersant | | HYDROPALAT 44 | Cognis Corp. USA of |
| | | | Cincinnati, OH |
| | | TAMOL 731 | Rohm and Haas of |
| | | TAMOL 1124 | Philadelphia, PA |
| colorant | | various ambers (brown) | Degussa Corp. of |
| | | | Parsippany, NJ |
| | | carbon black (black) | Cabot Corp. of Boston, |
| | | | MA |

TABLE II

| | Aqueous Polymer | | | |
|---|---|---|---|---|
| | Dispersion (APD) | Antioxidant (AO) | Ultraviolet Absorber | Water |
| Formula No. | (wt. %) | (wt. %) | (wt. %) | (wt. %) |
| 1 | 50 - ROVENE 4457 | 0 | 0 | 50 |
| 2 | 33 - ROVENE 4457 | 0 | 0 | 67 |
| 3 | 50 - ROVENE 4180 | 0 | 0 | 50 |
| 4 | 67 - ROVENE 4180 | 0 | 0 | 33 |
| 5 | 0 | 2 - OCTOLITE WL | 0 | 98 |
| 6 | 0 | 2 - OCTOLITE 424-50 | 0 | 98 |
| 7 | 49 - ROVENE 4457 | 1 - OCTOLITE WL | 0 | 50 |
| 8 | 49 - ROVENE 4457 | 1 - OCTOLITE 424-50 | 0 | 50 |
| 9 | 49 - ROVENE 4180 | 0 | 1 - MAZO BLS 292 | 50 |
| 10 | 49 - ROVENE 4180 | 0 | 1 - MAZO BNX 1077 | 50 |
| 11 | 49 - ROVENE 4180 | 0 | 1 - MAZO BLS 531 | 50 |
| 12 | 49 - ROVENE 4180 | 0 | 1 - MAZO BLS 1326 | 50 |
| 13 | 48 - ROVENE 4180 | 1 - OCTOLITE WL | 1 - MAZO BLS 531 | 50 |
| 14 | 48 - ROVENE 4180 | 1 - OCTOLITE 424-50 | 1 - MAZO BLS 531 | 50 |
| 15 | 48 - ROVENE 4180 | 1 - OCTOLITE WL | 1 - MAZO BLS 1326 | 50 |
| 16 | 48 - ROVENE 4180 | 1 - OCTOLITE 424-50 | 1 - MAZO BLS 1326 | 50 |
| 17 | 48 - ROVENE 4457 | 1 - OCTOLITE WL | 1 - MAZO BLS 531 | 50 |
| 18 | 48 - ROVENE 4457 | 1 - OCTOLITE 424-50 | 1 - MAZO BLS 531 | 50 |
| 19 | 48 - ROVENE 4457 | 1 - OCTOLITE WL | 1 - MAZO BLS 1326 | 50 |
| 20 | 48 - ROVENE 4180 | 1 - OCTOLITE 424-50 | 1 - MAZO BLS 1326 | 50 |

Table III provides an exemplary mulch protective composition and typical ranges of the ingredients.

TABLE III

| Component | Composition | Weight (gm) | % by Weight | Wt. % Range |
|---|---|---|---|---|
| Water | — | 1800 | 80.714 | |
| ultraviolet | Mazo BLS1326 dispersion (40 wt. | 100 | 4.485 | 0.5–6.0 |
| absorber | % Solids) | | | |
| antioxidant | OCTOLITE 625 dispersion (55 wt. | 110 | 4.933 | 1.0–6.0 |
| | % Solids) | | | |
| aqueous | ACRONAL S504 polymer | 100 | 4.485 | 4.0–10.0 |
| polymer | dispersion (50 wt. % Solids) | | | |
| dispersion | | | | |
| dispersant | TAMOL 731 (25 wt. % Solids) | 100 | 4.485 | 0.5–7.0 |
| colorant | burnt umber (50 wt. % Solids) | 20 | 0.898 | 0.5–2.0 |
| | Total | 2230 | 100.0 | |

The mulch coating material may be applied to the mulch by a wide variety of techniques sufficient to provide an amount of material on the mulch that is effective to prevent fading of the mulch for a prolonged period of time. Techniques may include spraying, dipping, or otherwise contacting the mulch with the protective material. A particularly effective method for coating the mulch is by the use of spray coating techniques wherein the protective material is applied from an aqueous mixture as described above. Commercially available pressure sprayers may be used to apply the protective material to the mulch. The protective material may be applied to the mulch before or after spreading the mulch in a landscaping location.

The amount of protective material applied to the mulch may vary depending on the length of time desired for the mulch to retain its aesthetic value. Accordingly, amounts applied to the mulch may range from about forty (40) grams to about four hundred (400) grams per pound of mulch treated. It is expected that applications in this range will enable the mulch to retain its aesthetic value for up to about one year or until about 50% to 75% of the mulch has decomposed and must be replaced.

In some embodiments of the invention, the protective material is applied in dry powder form. With these embodiments, once the powder is spread over the mulch to be protected, the powder dissolved, dispersed and activated by spraying water thereon.

The foregoing description of exemplary embodiments has been presented for purposes of illustration and description. The disclosed embodiments are not intended to be exhaustive or to limit the embodiments to the precise form disclosed. Obvious modifications or variations are possible in light of the above teachings. The embodiments are chosen and described in an effort to provide the best illustrations of the principles of described herein and its practical application, and to thereby enable one of ordinary skill in the art to utilize the disclosed embodiments with various modifications as are suited to the particular use contemplated.

1. A mulch protective composition comprising a mixture of water and at least one component selected from the group consisting of an antioxidant, an ultraviolet absorber, an aqueous polymer dispersion, and mixtures of two or more of the foregoing, which composition is effective to reduce fading of mulch over time.

2. The mulch protective composition of claim 1, wherein the antioxidant comprises a polymeric hindered phenol.

3. The mulch protective composition of claim 1, wherein the ultraviolet absorber is selected from the group consisting of hindered amines and benzophenones.

4. The mulch protective composition of claim 1, wherein the aqueous polymer dispersion is selected from the group consisting of carboxylated styrene-butadiene latex dispersion, ethylene vinyl acetate copolymer dispersion, alkyl acrylate acrylonitrile-styrene copolymer dispersion, and acrylic copolymer dispersion.

5. The mulch protective composition of claim 1, further comprising a dispersant.

6. The mulch protective composition of claim 1, further comprising a colorant.

7. The mulch protective composition of claim 1, wherein the composition comprises from about 0.0 to about 6.0 weight percent antioxidant, from about 0.0 to about 6.0 weight percent ultraviolet absorber, from about 0.0 to about 10.0 weight percent aqueous polymer dispersion, from about 0.0 to about 7.0 weight percent dispersant, and from about 0.0 to about 2.0 weight percent colorant.

8. The mulch protective composition of claim 1, wherein the composition comprises a spray-on coating composition.

9. Mulch comprising the protective composition of claim 1.

10. A method for reducing mulch fading comprising applying a protective composition to the mulch, wherein the protective composition comprises a mixture of water and at least one component selected from the group consisting of an antioxidant, an ultraviolet absorber, an aqueous polymer dispersion, and mixtures of two or more of the foregoing, which composition is effective to reduce fading of mulch over time.

11. The method of claim 10, wherein the protective composition is applied to the mulch after spreading the mulch in a desired location.

12. The method of claim 11, wherein the protective composition is sprayed onto the mulch.

13. The method of claim 10, wherein from about 40 grams to about 400 grams of the protective composition is applied per pound of mulch.

14. Non-fading mulch comprising wood chips and a protective composition applied to the wood chips, the protective composition comprising a mixture of water and at least one component selected from the group consisting of an antioxidant, an ultraviolet absorber, an aqueous polymer dispersion, and mixtures of two or more of the foregoing, which composition is effective to reduce fading of mulch over time.

15. The non-fading mulch of claim 14, wherein the antioxidant comprises a polymeric hindered phenol.

16. The non-fading mulch of claim 14, wherein the ultraviolet absorber is selected from the group consisting of hindered amines and benzophenones.

17. The non-fading mulch of claim 14, wherein the aqueous polymer dispersion is selected from the group consisting of carboxylated styrene-butadiene latex dispersion, ethylene vinyl acetate copolymer dispersion, alkyl acrylate acrylonitrile-styrene copolymer dispersion, and acrylic copolymer dispersion.

18. The non-fading mulch of claim 14, wherein the protective composition further comprises a dispersant.

19. The non-fading mulch of claim 14, wherein the protective composition further comprising a colorant.

20. The non-fading mulch of claim 14, wherein the protective composition comprises from about 0.0 to about 6.0 weight percent antioxidant, from about 0.0 to about 6.0 weight percent ultraviolet absorber, from about 0.0 to about 10.0 weight percent aqueous polymer dispersion, from about 0.0 to about 7.0 weight percent dispersant, and from about 0.0 to about 2.0 weight percent colorant.
